(19) United States
(12) Patent Application Publication
(10) Pub. No.: US 2023/0409410 A1
(43) Pub. Date: Dec. 21, 2023

(54) INTELLIGENT DISTRIBUTION OF COMPUTER TASKS ON EDGE COMPUTING DEVICES

(71) Applicant: INTERNATIONAL BUSINESS MACHINES CORPORATION, Armonk, NY (US)

(72) Inventors: Sudheesh S. Kairali, Kozhikode (IN); Malarvizhi Kandasamy, OMBR Layout (IN); Sarbajit K. Rakshit, Kolkata (IN)

(21) Appl. No.: 17/806,996

(22) Filed: Jun. 15, 2022

(51) Int. Cl. G06F 9/50; G06F 9/48

(52) U.S. Cl. CPC G06F 9/5083; G06F 9/4887

(57) ABSTRACT

A method for automatically selecting a computing device to offload and process a computer task is provided. The method may include automatically identifying an off-loadable computer task to be offloaded from a first computing device to a second computing device. The method may further include determining a scheduled time and an amount of time for processing the identified off-loadable computer task. The method may further include, based on the identified off-loadable computer task, the scheduled time, and the determined amount of time, automatically identifying available computing devices from the plurality of computing devices for processing the identified off-loadable computer task. The method may further include, selecting the computing device from for processing the off-loadable computer task, wherein selecting a moving edge computing device further includes coordinating the scheduled time and the amount of time for processing the identified off-loadable computer task with a determined travel plan.

### BACKGROUND

The present invention relates generally to the field of computing, and more specifically, to scheduling computer jobs/tasks based in part on detected travel information and availability of edge computing devices.

Generally, in computing, computer task/job scheduling may include an action of assigning certain computing tasks to different computers for processing based on computer resources associated with each computer. The computer resources may include processors, network links or expansion cards. Furthermore, the computer tasks may include threads, processes, data flows, or other scheduled jobs, cron jobs, backend jobs, and/or background jobs for maintaining computer software and/or hardware. For example, cron is a utility program that lets users input commands for scheduling computing tasks repeatedly at a specific time. Tasks scheduled in cron are called cron jobs, and cron jobs generally include background or backend non-interactive jobs. Users who set up and maintain software environments may use cron to schedule jobs (commands or shell scripts) to run periodically at fixed times, dates, or intervals. For example, cron jobs may typically be used for tasks such as automating system maintenance or administration, monitoring disk space, and scheduling backups—though its general-purpose nature makes it also useful for things like executing database updates, downloading files from the Internet, and downloading email at regular intervals. Furthermore, because of their nature, cron jobs are great for computers that work 24/7, such as servers. While cron jobs are used mainly by system administrators, they can be beneficial for web developers too. For instance, a website administrator can set up one cron job to automatically backup a site every day at midnight, another to check for broken links every Monday at midnight, and a third to clear your site cache every Friday at noon.

### SUMMARY

A method for automatically selecting a computing device, among a plurality of computing devices in a collaborative computing environment, to offload and process a computer task is provided. The method may include automatically identifying an off-loadable computer task to be offloaded from a first computing device to a second computing device from the plurality of computing devices, wherein the plurality of computing devices comprises a combination of stationary edge computing devices and moving edge computing devices. The method may further include determining a scheduled time for processing the identified off-loadable computer task and an amount of time necessary for processing the off-loadable computer task. The method may further include, based on the identified off-loadable computer task, the scheduled time, and the determined amount of time for processing the identified off-loadable computer, automatically identifying one or more available computing devices from the plurality of computing devices for processing the identified off-loadable computer task, whereby identifying the one more available computing devices further comprises detecting and correlating computer resource information, location and network information, and travel information associated with each computing device from the plurality of computing devices with the scheduled time and the amount of time necessary for processing the computer task. The method may further include, in response to automatically identifying the one or more available computing devices for processing the identified off-loadable computer task, selecting the computing device from the one or more available computing devices for processing the off-loadable computer task, wherein in response to selecting a moving edge computing device, coordinating the scheduled time and the amount of time for processing the identified off-loadable computer task with a determined travel plan associated with the selected moving edge computing device.

A computer system for automatically selecting a computing device, among a plurality of computing devices in a collaborative computing environment, to offload and process a computer task is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The method may include automatically identifying an off-loadable computer task to be offloaded from a first computing device to a second computing device from the plurality of computing devices, wherein the plurality of computing devices comprises a combination of stationary edge computing devices and moving edge computing devices. The method may further include determining a scheduled time for processing the identified off-loadable computer task and an amount of time necessary for processing the off-loadable computer task. The method may further include, based on the identified off-loadable computer task, the scheduled time, and the determined amount of time for processing the identified off-loadable computer, automatically identifying one or more available computing devices from the plurality of computing devices for processing the identified off-loadable computer task, whereby identifying the one more available computing devices further comprises detecting and correlating computer resource information, location and network information, and travel information associated with each computing device from the plurality of computing devices with the scheduled time and the amount of time necessary for processing the computer task. The method may further include, in response to automatically identifying the one or more available computing devices for processing the identified off-loadable computer task, selecting the computing device from the one or more available computing devices for processing the off-loadable computer task, wherein in response to selecting a moving edge computing device, coordinating the scheduled time and the amount of time for processing the identified off-loadable computer task with a determined travel plan associated with the selected moving edge computing device.

A computer program product for automatically selecting a computing device, among a plurality of computing devices in a collaborative computing environment, to offload and process a computer task is provided. The computer program product may include one or more computer-readable storage devices and program instructions stored on at least one of the one or more tangible storage devices, the program instructions executable by a processor. The computer program product may include program instructions to automatically identify an off-loadable computer task to be offloaded from a first computing device to a second computing device from the plurality of computing devices, wherein the plurality of computing devices comprises a combination of stationary edge computing devices and moving edge computing devices. The computer program product may also include program instructions to determine a scheduled time for processing the identified off-loadable computer task and an amount of time necessary for processing the off-loadable computer task. The computer program product may further include program instructions to, based on the identified off-loadable computer task, the scheduled time, and the determined amount of time for processing the identified off-loadable computer, automatically identifying one or more available computing devices from the plurality of computing devices for processing the identified off-loadable computer task, whereby identifying the one more available computing devices further comprises detecting and correlating computer resource information, location and network information, and travel information associated with each computing device from the plurality of computing devices with the scheduled time and the amount of time necessary for processing the computer task. The computer program product may also include program instructions to, in response to automatically identifying the one or more available computing devices for processing the identified off-loadable computer task, selecting the computing device from the one or more available computing devices for processing the off-loadable computer task, wherein in response to selecting a moving edge computing device, coordinating the scheduled time and the amount of time for processing the identified off-loadable computer task with a determined travel plan associated with the selected moving edge computing device

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to one embodiment;

FIG. 2 an example diagram illustrating internal components of a program for automatically detecting and processing a computer input event comprising one or more intents according to one embodiment;

FIG. 3A is an operational flowchart illustrating the steps carried out by a program for automatically selecting a computing device, among a plurality of computing devices in a collaborative computing environment, to offload and process a computer task according to one embodiment;

FIG. 3B is an operational flowchart illustrating the steps for automatically identifying one or more available computing devices for processing the computer task that corresponds to a step carried out by the program for automatically selecting a computing device, among a plurality of computing devices in a collaborative computing environment, to offload and process a computer task according to one embodiment;

FIG. 4 is a block diagram of the system architecture of the program for automatically selecting a computing device, among a plurality of computing devices in a collaborative computing environment, to offload and process a computer task according to one embodiment;

FIG. 5 is a block diagram of an illustrative cloud computing environment including the computer system depicted in FIG. 1, in accordance with an embodiment of the present disclosure; and

FIG. 6 is a block diagram of functional layers of the illustrative cloud computing environment of FIG. 5, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate generally to the field of computing, and more particularly, to automatically selecting a computing device, among a plurality of computing devices in a collaborative computing environment, to offload and process a computer task. Specifically, the following described exemplary embodiments provide a system, method and computer program product for a collaborative computing environment that includes both stationary edge computing devices and nonstationary (i.e. moving) edge computing devices such that the system, method and computer program product may coordinate offloading computer tasks on the nonstationary devices by determining and correlating travel plans and routes associated with the nonstationary computing devices with a time for processing the computer task. Therefore, the exemplary embodiments have the capacity to improve the technical field associated with offloading computing tasks from a first computer device to a second computing device in a collaborative computing environment that includes both stationary devices and nonstationary devices by correlating data associated with computer tasks with travel information. More specifically, based on an identified off-loadable computer task, a scheduled time for processing the identified off-loadable computer task, and the determined amount of time for processing the identified off-loadable computer, the system, method and computer program product may automatically identify one or more available computing devices from the plurality of computing devices for processing the identified off-loadable computer task, whereby identifying the one more available computing devices further comprises detecting and correlating computer resource information, location and network information, and travel information associated with each computing device from the plurality of computing devices with the scheduled time and the amount of time necessary for processing the identified off-loadable computer task.

More specifically, and as previously described with respect to computer tasks/jobs, certain computing tasks/jobs may be scheduled and/or run periodically at different times, dates, or intervals. For example, scheduled computer tasks/jobs may include database updates, automated system maintenance or administration, disk space monitoring, and backups. However, and as previously described, scheduling a computer task/job may also require resources to perform the scheduled computer tasks. While the process of assigning resources for a scheduled computer task may be simple when using traditional computing paradigms such as load balancing, such a process becomes more complicated in cloud computing environments that include a collection of collaborative edge computing devices. Specifically, cloud computing allows access to computing resources (software, hardware, and platform) remotely through a network. Furthermore, recent trends in edge computing extends cloud computing and Internet of Things (IoT) devices to the edge of a network. Edge computing may provide more computational power and resources closer to end users by increasing a number of networking endpoints (i.e. edge computing devices) and locating the endpoints nearer to consumers and/or other devices.

As such, based on the location of certain networking endpoints and/or edge computing devices, a cloud data center (or server) may be able to offload certain computer tasks to the edge computing devices located within a threshold range of the network (and/or network endpoint) that is shared between the cloud data center and the edge computing devices which are capable of processing the potential offloaded computer task/job. However, while certain edge computing devices within a network may be stationary, other edge computing devices may be in motion and sometimes in and out of range of the network. Therefore, while the edge computing devices that are in motion may provide necessary computing resources that a cloud data center may use to offload certain computing tasks, such edge computing devices may not be accessible at certain times depending on the location and route of the edge computing devices as well as a time it takes to complete the offloaded computer task/job. For example, an edge computing device that may be in motion may complete a certain computer task/job, however, results from the completed computer task/job may not be sent back to the cloud server since the edge computing device may have moved out of a threshold range of the network that is shared between the cloud data center/server and the moving edge computing device.

Therefore, it may be advantageous, among other things, to provide a method, computer system, and computer program product for automatically selecting an edge computing device, among a plurality of edge computing devices in a collaborative computing environment, to offload and process a computer task. Specifically, the method, computer system, and computer program product may automatically identify a subset of edge computing devices capable of processing the computer task from the plurality of edge computing devices, wherein identifying the subset of edge computing devices further comprises detecting a requisite amount of computer resources needed for processing the computer task from each edge computing device in the subset of edge computing devices, and wherein the subset of edge computing devices includes a combination of one or more stationary edge computing devices and one or more moving edge computing devices. Furthermore, the method, computer system, and computer program product may automatically predict an amount time necessary for completing the computer task. Next, the method, computer system, and computer program product may automatically determine and predict location information and route information for each of the edge computing devices in the subset of edge computing devices. Then, the method, computer system, and computer program product may automatically select an optimal edge computing device for processing the computer task from the subset of edge computing devices, wherein automatically selecting the optimal edge computing device further comprises selecting the optimal edge computing device by correlating the determined and predicted location information and route information with the amount of time for completing the computer task such that the optimal edge computing device is predicted to complete the computer task within the amount of time while in a threshold range of the collaborative computing environment.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

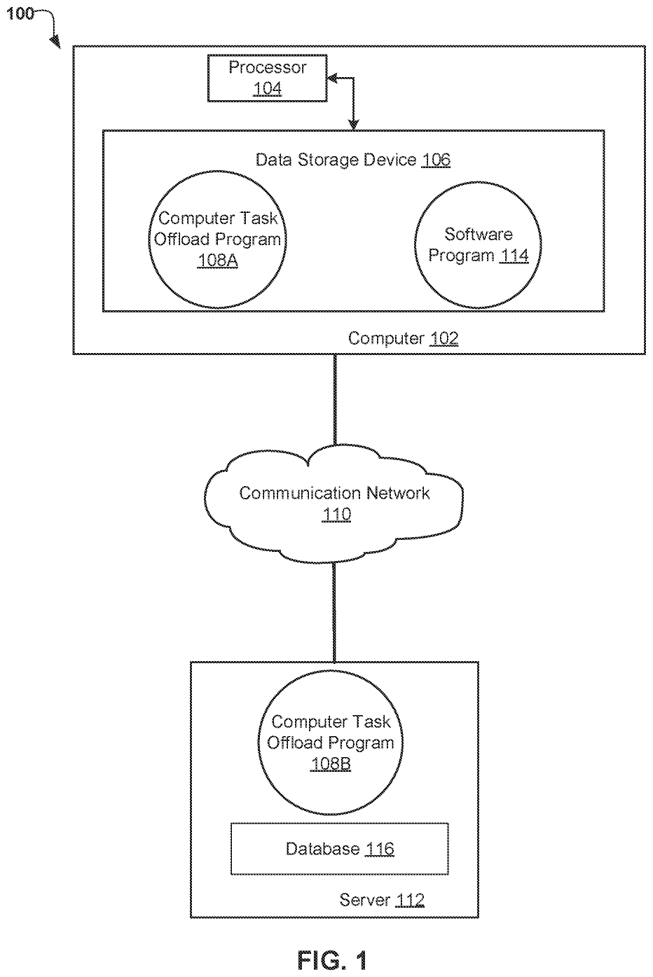

Referring now to FIG. 1, an exemplary networked computer environment 100 in accordance with one embodiment is depicted. The networked computer environment 100 may include a computer 102 with a processor 104 and a data storage device 106 that is enabled to run a computer task offload program 108A and a software program 114, and may also include a microphone (not shown). The software program 114 may include one or multiple application programs such as an internet program and/or one or more mobile/computer apps running on a computer 102, such as a mobile phone device, desktop, and/or laptop. The computer task offload program 108A may communicate with the software program 114. The networked computer environment 100 may also include a server 112 that is enabled to run a computer task offload program 108B and the communication network 110. The networked computer environment 100 may include a plurality of computers 102 and servers 112, only one each is shown for illustrative brevity. For example, the plurality of computers 102 and servers 112 may include a plurality of interconnected and collaborative devices, such as network endpoints, edge computing devices, and cloud data center/servers.

According to at least one implementation, the present embodiment may also include a database 116, which may be running on server 112. The communication network 110 may include various types of communication networks, such as a wide area network (WAN), local area network (LAN), a telecommunication network, a wireless network, a public switched network and/or a satellite network. It may be appreciated that FIG. 1 provides only an illustration of one implementation and does not imply any limitations with regard to the environments in which different embodiments may be implemented. Many modifications to the depicted environments may be made based on design and implementation requirements.

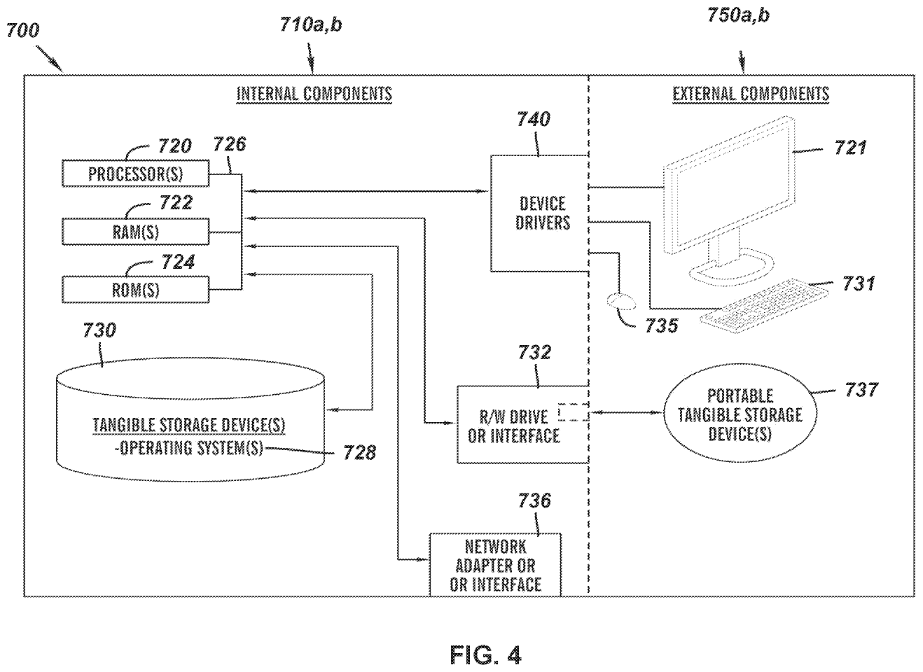

The computer 102 may communicate with server computer 112 via the communications network 110. The communications network 110 may include connections, such as wire, wireless communication links, or fiber optic cables. As will be discussed with reference to FIG. 4, server computer 112 may include internal components 710a and external components 750a, respectively, and client computer 102 may include internal components 710b and external components 750b, respectively. Server computer 112 may also operate in a cloud computing environment and/or service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. As such, server 112 may, for example, include a cloud data center or cloud server. Furthermore, computer 102 may be, for example, a mobile device, a telephone, a personal digital assistant, a netbook, a laptop computer, a tablet computer, a desktop computer, an internet of things (IoT) device, an augmented reality (AR) device, a vehicle computer device, or any type of computing device capable of running a program and accessing a network. As previously described, the networked computer environment 100 may include a plurality of computers 102 and servers 112, only one each is shown for illustrative brevity in FIG. 1. According to various implementations of the present embodiment, the computer task offload program 108A, 108B may interact with a database 116 that may be embedded in various storage devices, such as, but not limited to, a mobile device 102, a networked server 112, or a cloud storage service.

According to the present embodiment, a program, such as a computer task offload program 108A and 108B may run on the computer 102 and/or on the server computer 112 via a communications network 110. The computer task offload program 108A, 108B may automatically and cognitively select an edge computing device (such as computer 102), among a plurality of edge computing devices in the network computing environment 100, for performing a computer task. Specifically, one or more computers 102, such as edge computing devices that may include mobile devices and/or vehicle computing devices, may run a computer task offload program 108A, 108B, that may interact with one or more servers 112 that are also running the computer task offload program 108A, 108B to allow the computer task offload program 108A, 108B to select a computer 102 to offload certain computer tasks. Specifically, the computer task offload program 108A, 108B may automatically identify a subset of edge computing devices that are capable of processing the computer task from a plurality of edge computing devices, wherein identifying the subset of edge computing devices further comprises detecting a requisite amount of computer resources needed for processing the computer task from each edge computing device in the subset of edge computing devices, and wherein the subset of edge computing devices includes a combination of one or more stationary edge computing devices and one or more moving edge computing devices. Furthermore, the computer task offload program 108A, 108B may automatically predict an amount time necessary for completing the computer task. Next, the computer task offload program 108A, 108B may automatically determine and predict location information and route information for each of the edge computing devices in the subset of edge computing devices. Then, the computer task offload program 108A, 108B may automatically select an optimal edge computing device for processing the computer task from the subset of edge computing devices, wherein automatically selecting the optimal edge computing device further comprises selecting the optimal edge computing device by correlating the determined and predicted location information and route information with the amount of time for completing the computer task such that the optimal edge computing device is predicted to complete the computer task within the amount of time while in a threshold range of the collaborative computing environment.

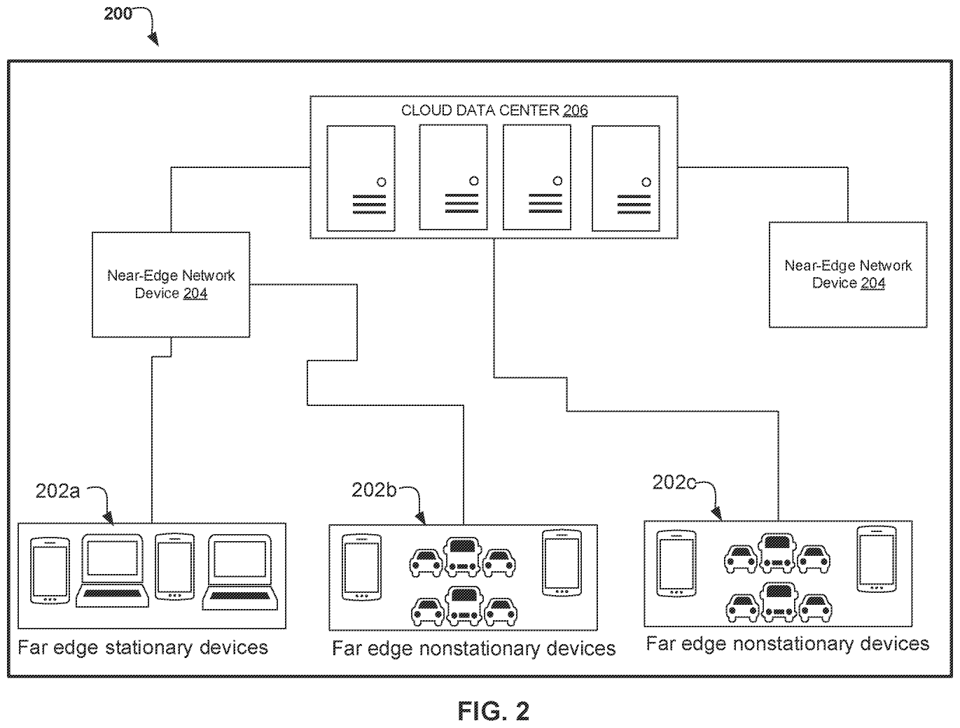

Referring now to FIG. 2, an expanded view 200 of the network computer environment as previously described in FIG. 1 according to one embodiment is depicted. Specifically, and as previously described with respect to FIG. 1, the networked computer environment may be a collaborative computing environment that includes a plurality of computers 102 (FIG. 1) and servers 112 (FIG. 1), only one of each is shown for illustrative brevity in FIG. 1. However, as further depicted in FIG. 2, the plurality of computers 102 (FIG. 1) may include sets of interconnected and collaborative edge computing devices 202a, 202b, 202c that may further include computing devices such as a mobile device, a telephone, a personal digital assistant, a netbook, a laptop computer, a tablet computer, a desktop computer, an internet of things (IoT) device, an augmented reality (AR) device, a vehicle computer device, or any type of computing device capable of running a program and accessing a network. According to one embodiment, and as previously described in FIG. 1, the edge computing devices 202a, 202b, 202c may communicate with one or more servers, as depicted by cloud data center 206, via a communication network (not shown in FIG. 2 but previously described at 110 in FIG. 1).

According to one embodiment, the edge computing devices 202a, 202b, 202c may communicate directly with the cloud data center 206 via the communication network 110 (FIG. 1), or may communicate with the cloud data center 206 through a near edge network computing device 204 (which may include one or more network endpoints, routers, switches, etc., and/or another edge computing device) that may also be a part of the collaborative computing environment and used to communicate via the communication network 110 in. More specifically, the near edge network computing device 204 may be used to extend a range of communication for the communication network 110 (FIG. 1) between the edge computing devices 202a, 202b, 202c and the cloud data center 206.

According to one embodiment, the range of communication and network capabilities associated with the edge computing devices 202a, 202b, 202c and the cloud data center 206 may be pre-defined and/or measured based on a number of different network factors with one factor being based on distance (miles (mi) and kilometers (km)), while other factors may include the emitted power or the sensibility of network receivers associated with each of the edge computing devices 202a, 202b, 202c and the cloud data center 206. Thus, according to one embodiment, the range of communication may be defined based on design, and more specifically, based on different types of computer networking devices/equipment that may be integrated with the edge computing devices 202a, 202b, 202c and the cloud data center 206 and the range associated with the different types of computer networking devices/equipment. Therefore, the measured distance (along with other factors such as the strength of a network signal itself) between the cloud data center 206 and a respective edge computing device from a set of edge computing devices 202a, 202b, 202c may provide an indication of whether the edge computing device is within the range of communication with the cloud data center 206 as well as with other edge computing devices. More specifically, for example, based on the communication network and the type of computer networking device integrated with the edge computing devices 202a, 202b, 202c and the cloud data center 206, the range of communication between the edge computing devices 202a, 202b, 202c and the cloud data center 206 may have a maximum range of 40 km. Therefore, an edge computing device 202a, 202b, 202c that travels beyond a distance of 40 km from the cloud data center 206 and/or from another edge computing device 202a, 202b, 202c may lose communication and/or connectivity with the cloud data center 206 or that other respective edge computing device 202a, 202b, 202c via the communication network 110 (FIG. 1).

According to one embodiment, the computer task offload program 108A, 108B may also use the distance (along with the other network factors) between the edge computing devices 202a, 202b, 202c and the cloud data center 206 to determine whether an edge computing device is a near edge computing device or a far edge computing device with respect to the cloud data center 206 and/or another edge computing device. Specifically, following the previous example of 40 km and for the cloud data center 206, the computer task offload program 108A, 108B may determine that an edge computing device between a distance of 0 km-20 km from the cloud data center 206 may be considered a near edge computing device having good connectivity to the cloud data center 206 via the communication network 110 (FIG. 1), and an edge computing device between a distance of 20 km-40 km from the cloud data center 206 may be considered a far edge computing device having limited connectivity to the cloud data center 206 via the communication network 110 (FIG. 1). As depicted in FIG. 2, for example, edge computing devices 202a, 202b, 202c may be considered far edge computing devices based on a certain point of time in a day (however, at a different point of time in the day, such designations of near edge and far edge may change). Also, according to one embodiment, a correlation between the distance of an edge computing device and the designation of the edge computing device as a near edge or far edge computing device may also be based on design. For example, the computer task offload program 108A, 108B may receive user feedback by presenting a user interface on computer 102 (FIG. 1) whereby a user may be able to select and define which distance constitutes a near edge computing device and far edge computing device.

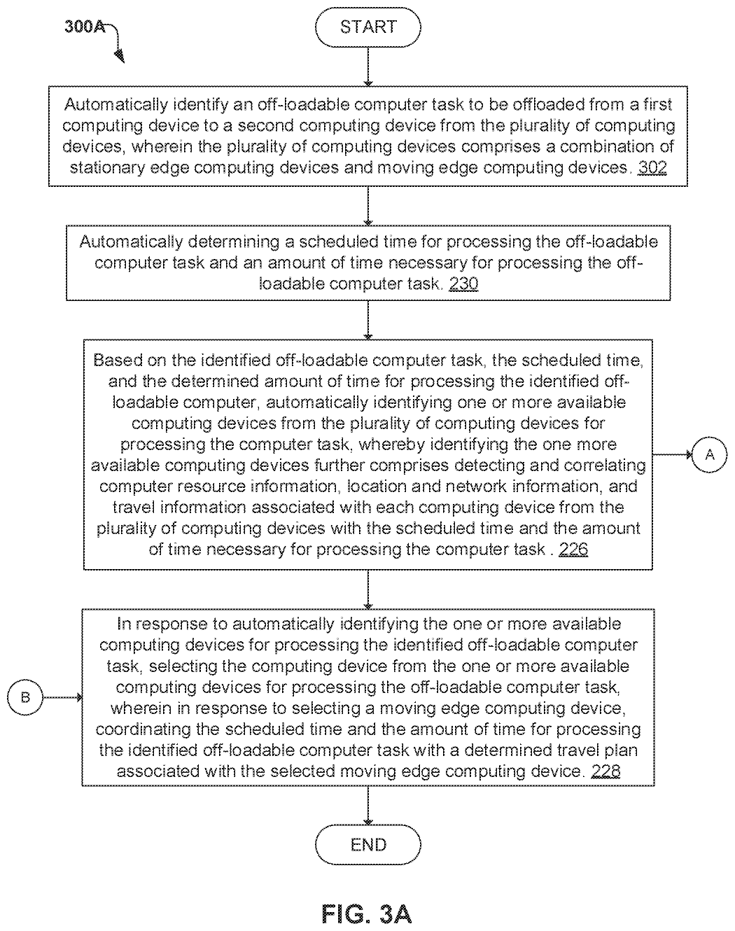

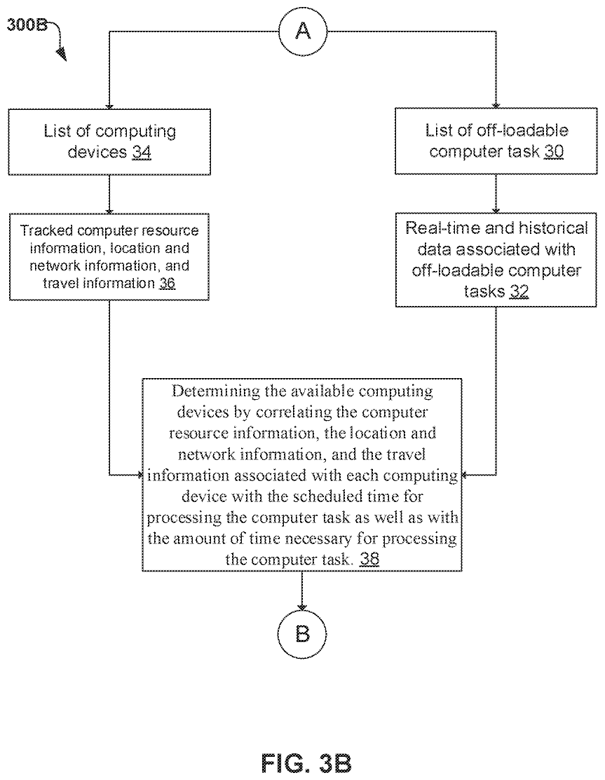

Furthermore, as previously described, the edge computing devices 202a, 202b, 202c may include stationary (non-moving) edge computing devices and nonstationary (i.e. moving/traveling) edge computing devices. As previously described, and at a certain point in time, edge computing devices 202a, 202b, 202c may be considered far edge computing devices. However, while edge computing devices 202a may be stationary edge computing devices (meaning that the location of the edge computing devices does not change within a given time period), edge computing devices 202b and 202c may include nonstationary edge computing devices such that the location of these edge computing devices may change within a given time period. More specifically, for example, while an edge computing device from 202c may at a certain point in time in a given day, such as 2:00 pm, may be considered a far edge computing device for the cloud data center 206 based on the distance of the edge computing device from the cloud data center 206, the edge computing device 202c may either be constantly in motion or may travel to a different location, and by 2:30 pm the edge computing device 202c may be at a distance that defines a near edge computing device (or in another case, may travel further out of range of the cloud data center 206 altogether—i.e. beyond 40 km—and thus may still be considered a far edge). As will be further described with respect to FIGS. 3A and 3B, the computer task offload program 108A, 108B may determine the distance and connectivity information along with the location information and travel/route information associated with the edge computing devices 202a, 202b, 202c and the cloud data center 206 to correlate the combination of information with a scheduled time for processing the off-loadable computer task as well as with the amount of time it takes to process the off-loadable computer task/job. In turn, the computer task offload program 108A, 108B may use the correlation of information to select a respective edge computing device from the edge computing devices 202a, 202b, 202c for processing the off-loadable edge computer task/job.

Referring now to FIG. 3A, an operational flowchart 300A illustrating the steps carried out by the computer task offload program 108A, 108B for automatically selecting a computing device, among multiple computing devices in a collaborative computing environment, to offload and process a computer task is depicted. Specifically, at 302, the computer task offload program 108A, 108B may automatically identify an off-loadable computer task/job which may be offloaded from a first computing device to a second computing device from the multiple computing devices, whereby the multiple computing devices may include a combination of stationary computing devices and nonstationary/traveling edge computing devices as depicted in FIG. 2. According to one embodiment, the first computing device may include a server or edge computing device from the one or more servers 206 (as depicted by cloud data center 206 in FIG. 2) and edge computing devices 202a, 202b, 202c as also previously described in FIG. 2. Furthermore, the second computing device may include a different server or edge computing device from the one or more servers 206 and edge computing devices 202a, 202b, 202c similarly described in FIG. 2 that is different from the first computing device. Furthermore, according to one embodiment, the off-loadable computer task may include any computer task capable of being offloaded from the first computing device to the second computing device. Examples of off-loadable computer tasks may include certain types of cron jobs, scheduled jobs, background jobs, backend jobs, data flows, computer threads, and/or any computer task that is not centralized on one computer (i.e. the first computer) such that the computer task can be distributed to one or more computers on a network (such as the second computer).

Next, at 304, in addition to identifying an off-loadable computer task that may be offloaded from the first computing device to the second computing device, the computer task offload program 108A, 108B may also determine a scheduled time for processing the off-loadable computer task and an amount of time necessary for processing the off-loadable computer task. According to one embodiment, the off-loadable computer task may be scheduled for processing in real-time or scheduled for processing for some time in the future based on defined operations associated with the collaborative computing environment described in FIG. 2. Furthermore, the computer task offload program 108A, 108B may determine the scheduled time and/or the amount of time necessary for processing the computer task based on information such as a size of the data for the computer task, whether the computer task requires downloading and uploading data, and historical data associated with the computer task. More specifically, for the historical data, the computer task offload program 108A, 108B may include a database, such as database 116 (FIG. 1), to store historical data associated with different computer tasks including the identified off-loadable computer task, whereby the historical data may include previous execution/processing of the computer tasks. For example, based on stored historical data associated with the identified off-loadable computer task, such as a cron job, the computer task offload program 108A, 108B may determine that the cron job historically takes approximately 5 minutes to complete based on previous processing of the cron job, whereby processing the cron job may include completing the cron job as well as uploading results from the completed computer task back to the first computing device when required.

According to one embodiment, the stored historical data for a given computer task may be based on previous processing of the computer task and may be further based specifically on previous processing of the computer task by a specific computing device. For example, while the stored historical data indicates that the computer task takes 5 minutes to process on one type of edge computing device, the stored historical data may also indicate that the computer task takes 6 minutes to process on a different type of edge computing device, whereby the difference in time may be attributed to the different computing resources associated with the edge computing devices 202a, 202b, 202c, such as the computer capabilities/properties (including specific computing equipment) associated with the different edge computing devices, the networking capabilities of the different edge computing devices (such as connectivity, and uploading and downloading speeds), and/or the distance of the edge computing devices from the first computing device. As such, the stored historical data for a given computer task may include data such as an amount of time previously taken to complete the computer task, whether processing the computer tasks requires downloading and uploading of data, and data corresponding to the computing device specifically used for previously processing the computer task (including the computing properties associated with the computing device, and correlations between the amount of time for processing the computer task and the computing properties of the computing device). In turn, the computer task offload program 108A, 108B may use the historical data, as well as real-time information regarding the size of the data of the off-loadable computer task and whether the computer task requires further downloading and/or uploading of data, to determine/calculate an approximate time for completing the identified off-loadable computer task.

Thereafter, at 306, based on the identified off-loadable computer task, the scheduled time, and the determined amount of time for completing the identified off-loadable computer, the computer task offload program 108A, 108B may automatically identify one or more available computing devices for processing the computer task, whereby identifying the one more available computing devices further includes continuously and dynamically (i.e. in real-time) detecting and correlating computer resource information, location and network information, and travel information associated with each computing device from the plurality of computing devices with the scheduled time and the amount of time necessary for processing the computer task. As previously described, the computer task offload program 108A, 108B may select a computing device among a plurality of computing devices in a collaborative computing environment to offload and process a computer task. More specifically, the computer task offload program 108A, 108B may automatically identify an off-loadable computer task/job which may be offloaded from a first computing device to a second computing device from the plurality of computing devices. Accordingly, the computer task offload program 108A, 108B may select the second computing device by first identifying one or more available computing devices for completing the computer task. More specifically, according to one embodiment, the computer task offload program 108A, 108B may automatically identify available computing devices by detecting the computer resources associated with the computing devices from the plurality of computing devices as well as by detecting location and network information and travel information associated with the computing devices.

Specifically, and as previously described, the computer task offload program 108A, 108B may operate in a collaborative computing environment whereby the environment includes a combination of stationary and nonstationary devices such that one or more computing devices may include edge computing devices 202a, 202b, 202c that may be stationary, in current travel, in constant travel, and/or may travel at a future time. Therefore, while certain stationary computing devices may be well capable of processing the computer task, the computer task offload program 108A, 108B may determine that a nonstationary (i.e. moving/traveling) computing device may be more suited for completing the computer task by determining, for example, that the nonstationary computing device may take less time for processing the computer task, experience better connectivity to the first computing device (for example, based on distance), and/or that the nonstationary device is equipped with more advanced computer resources for completing the computer task. The process for automatically identifying one or more available computing devices for processing the computer task at step 306 is further described in more detail with respect to FIG. 3B as denoted by “A” in both FIGS. 3A and 3B.

Specifically, an operational flowchart 300B illustrating the steps for automatically identifying one or more available computing devices for processing the computer task that corresponds to step 306 according to one embodiment is depicted. More specifically, and as previously described, the computer task offload program 108A, 108B may continuously and dynamically maintain a list of off-loadable computer tasks in the collaborative computing environment as further depicted at step 30 in FIG. 3B. For example, the computer task offload program 108A, 108B may identify and maintain a list of off-loadable computer tasks further including the times the off-loadable tasks may be scheduled to be processed as previously described at steps 302 and 304. Furthermore, and as previously described at step 304 in FIG. 3A, the computer task offload program 108A, 108B may maintain real-time and historical data associated with the off-loadable computer tasks which is similarly depicted at 32 in FIG. 3B.

As depicted at 34 in FIG. 3B, the computer task offload program 108A, 108B may identify one or more available computing devices by first continuously and dynamically maintaining a list of computing devices in the collaborative computing environment previously described in FIG. 2 as well as continuously and dynamically detect the computer resources associated with each computing device. More specifically, and as previously described in FIG. 2, the list of computing devices may include the cloud data center 206 and the edge computing devices 202a, 202b, 202c, which may further include stationary (non-moving) edge computing devices and nonstationary (i.e. moving/traveling) edge computing devices. The computer task offload program 108A, 108B may detect the computer resources associated with the edge computing devices 202a, 202b, 202c by, for example, detecting computer capabilities and properties associated with the computing devices such as CPU and processor information/capabilities, storage information and capabilities, upload and download speed/capabilities, network device capabilities, etc. However, as previously described, at a certain point in time with respect to the cloud data center 206, edge computing devices 202a and 202b may be considered far edge computing devices (i.e. having limited connectivity to the cloud data center 206) while edge computing devices 202c may include near edge computing devices (having better or above average connectivity to the cloud data center 206). Thus, while certain edge computing devices 202a may be stationary edge computing devices, edge computing devices 202b and 202c may include nonstationary edge computing devices such that the location of these edge computing devices may change within a given time period, and therefore, connectivity to the cloud data center 206 may change which may also affect the computer resource information such as network capability.

Accordingly, at 36 in FIG. 3B, the computer task offload program 108A, 108B may detect/track computer resource information, location and network information, and travel information associated with each of the computing devices in the collaborative computing environment based on real-time and historical data associated with the computing devices. For example, the computer task offload program 108A, 108B may use global position satellite (GPS) data, networking information, and/or computer registration data associated with each edge computing device 202a, 202b, 202c to detect the location and network capabilities for each edge computing device 202a, 202b, 202c at any given time. Additionally, the computer task offload program 108A, 108B may use the GPS data, the networking information, and stored previous route information to detect the travel information associated with each edge computing device 202a, 202b, 202c, and more specifically, the nonstationary edge computing devices. More specifically, according to one embodiment, detecting the travel information may further include mapping and monitoring different routes associated with the different nonstationary computing devices, including identifying and analyzing traffic patterns and previously stored information regarding previous travel information associated with a given nonstationary computing device. For example, certain nonstationary edge computing devices may have pre-defined routes based on a pre-defined operational setup of the collaborative computing environment. Accordingly, a nonstationary edge computing device, such as a vehicle, may constantly run on a pre-defined travel plan that is consistent with the operational needs of the collaborative computing environment. Therefore, the computer task offload program 108A, 108B may use the pre-defined travel plan information to detect and predict where a nonstationary edge computing may be located currently and/or in the future.

According to one embodiment, the computer task offload program 108A, 108B may also analyze traffic patterns to detect/predict travel patterns for a given nonstationary computing device. According to one embodiment, the computer task offload program 108A, 108B may also use the database 116 (FIG. 1) to store historical/previous travel routes, travel plans, and travel patterns associated with a given nonstationary computing device. Additionally, the computer task offload program 108A, 108B may use the database 116 (FIG. 1) to store historical data associated with each computing device that includes previously processed computer tasks, previous computing capabilities (which may also be correlated with a specific time of day to determine when a given computer device experiences peak processing times), previous download and upload speeds, previous network connectivity and/or connectivity issues, and other information regarding previous operations of the computer devices. In turn, the computer task offload program 108A, 108B may continuously track the GPS data, current travel data, traffic pattern data, operational data, networking data, stored historical travel data, and stored historical computing device data (including previous operations) to continuously detect and predict the available computing devices for the computer task.

In turn, at 38 in FIG. 3B, the computer task offload program 108A, 108B may correlate the tracked computer resource information, location and network information, and travel information associated with each computing device with the scheduled time for processing the computer task as well as with the amount of time necessary for processing the computer task to determine the available computing devices. Specifically, according to one embodiment, the computer task offload program 108A, 108B may use the computer resource information, location and network information, and travel information to continuously assess and predict whether a computing device from the stationary and nonstationary computing devices provides the necessary resources and connectivity for processing the computer task at the time the computer task may be scheduled to be processed as well as in the determined amount of time for processing the computer task. For example, for a given computer task and edge computing device 202a, 202b, 202c, the computer task offload program 108A, 108B may predict expected download and upload times in cases where data from the computer task needs to be downloaded from and/or uploaded to another computing device. Furthermore, based on the tracked location/network and travel information, the computer task offload program 108A, 108B may coordinate and correlate travel patterns associated with the nonstationary edge computing devices to determine whether a given nonstationary edge computing device is capable of processing the computer task at the scheduled time and within the amount of time that is determined for the computer task. As indicated by the letter “B” in FIGS. 3B and 3A, based on the identified one or more available computing devices, the computer task offload program 108A, 108B may then select a computing device for offloading and processing the computer task as.

Specifically, and referring back now to FIG. 3A, at 308, in response to automatically identifying the one or more available computing devices for processing the computer task, the computer task offload program 108A, 108B may then select a computing device for processing the off-loadable computer task from the first computing device based on the identified one or more available computing devices, whereby in response to selecting a nonstationary (i.e. moving) edge computing device, the computer task offload program 108A, 108B may coordinate the scheduled time and the amount of time for processing the off-loadable computer task with a determined travel plan associated with the selected nonstationary device. According to one embodiment, the selection may be based on a combination of the computer resources associated with the selected computing device and an expected time of completing the processing of the computing task for the selected computing device. Therefore, according to one embodiment, the selected computing device may be an optimal option for processing the computer task by processing the computer task at the scheduled time and/or within an amount of time faster than other computing devices. In some cases, and according to one embodiment, in response to identifying multiple computing devices that are suitable for offloading and processing of the computer task, the computer task offload program 108A, 108B may use traditional load balancing techniques to allocate/distribute the computer task. Furthermore, according to one embodiment, in cases where the selected computing device may fail to process the computer task (for example, by losing connectivity before or during processing, or receiving an error during processing), the computer task offload program 108A, 108B may redirect the computer task to another device from the identified one or more available devices.

Furthermore, and as previously described, in response to selecting a nonstationary edge computing device, the computer task offload program 108A, 108B coordinates the scheduled time and the amount of time for processing the off-loadable computer task with a determined travel plan associated with the selected nonstationary device. Specifically, and as also previously described, the computer task offload program 108A, 108B may use the computer resource information, location and network information, and travel information to continuously assess and predict whether a computing device from the stationary and nonstationary computing devices provides the necessary resources and connectivity for processing the computer task at the time the computer task may be scheduled to be processed as well as in the determined amount of time for processing the computer task. For example, for a given computer task and edge computing device 202a, 202b, 202c, the computer task offload program 108A, 108B may predict expected download and upload times in cases where data from the computer task needs to be downloaded from and/or uploaded to another computing device. Furthermore, based on the location/network and travel information, the computer task offload program 108A, 108B may coordinate and correlate travel patterns associated with the nonstationary edge computing devices to determine whether a given nonstationary edge computing device is capable of processing the computer task at the scheduled time and within the determined amount of time that is typical for the computer task

For example, based on the computer resource information, the location and network information, and the travel information for a given nonstationary computing device from the edge computing devices 202a, 202b, 202c (FIG. 2), the computer task offload program 108A, 108B may determine that the nonstationary computing device may be selected for offloading a scheduled computer task from the cloud data center 206 (FIG. 2) to the nonstationary computing device. However, according to one embodiment, based on the detected and analyzed location/network information and travel information, the computer task offload program 108A, 108B may determine that the nonstationary computing device may lose connectivity with the cloud data center 206 (FIG. 2) at certain point in time during or when the computer task is scheduled to be processed. Additionally, the computer task offload program 108A, 108B may determine that processing the computer task requires certain content from the computer task to be downloaded onto a selected computing device such as the nonstationary computing device. Thus, according to one embodiment, selecting the nonstationary computing device may further include determining and coordinating a travel plan with the scheduled time and amount of time for processing the computer task. For example, the computer task offload program 108A, 108B may determine how much time is necessary for downloading the computer task. In turn, according to one embodiment, the computer task offload program 108A, 108B may use the location and travel information to coordinate pre-fetching the downloadable content associated with the computer task at a time before the computer task is scheduled, and/or at time before the nonstationary computing device loses connectivity with the cloud data center 206, such that the nonstationary computing device may be able to process the downloadable content associated with the computer task even when offline as well as upload the results back to the cloud data center 206 when the necessary (or threshold) amount of connectivity is restored (which may further be based on location and travel information).

According to another example, the computer task offload program 108A, 108B may optionally reroute a nonstationary computing device to accommodate or make the nonstationary device available for processing the computer task. Specifically, in certain cases, a nonstationary computing device may be unused and/or used in a limited threshold capacity. However, the limited-used nonstationary computing device may be on a travel plan/pattern that does not provide the threshold connectivity to the cloud data center 206 (FIG. 2) for offloading and processing a certain scheduled computer task/job. Therefore, in addition to leveraging traditional load balancing techniques associated with collaborative computing environments, the computer task offload program 108A, 108B may determine that the limited-used nonstationary computing device may be an optimal choice for processing the computer task. As such, the computer task offload program 108A, 108B may alter a previous travel plan/route of the limited-used nonstationary computing device to a determined new travel plan/route that provides the threshold connectivity to the cloud data center 206 for processing the computer task at or some time near the scheduled time for processing the computer task.

According to another example, the computer task offload program 108A, 108B may determine that no computing device may be available for processing the computer task at a scheduled time. Specifically, for example, the computer task offload program 108A, 108B may determine that a computer task may be incapable of being processed on the cloud data center 206 at a certain scheduled time (for example, due to an expected overload of processing on the cloud data center 206), and may further determine that no other computing device (stationary and nonstationary) may be available to off-load the computing task (which may similarly be due to processing loads associated with the edge computing devices and/or travel plans for computing devices such as the nonstationary edge computing devices). Therefore, the computer task offload program 108A, 108B may determine a travel plan by optionally implement a travel freeze at a certain point in time before the scheduled time for processing the computer task to ensure that a nonstationary edge computing device is available at the scheduled time for processing the computer task. More specifically, implementing the travel freeze may include stopping travel of at least one nonstationary edge computing device at the certain point in time while the nonstationary edge computing devices may be in range and able to process the computer task such that the nonstationary edge computing device is available at the scheduled time for processing the computer task.

It may be appreciated that FIGS. 1-3B provide only illustrations of one implementation and does not imply any limitations with regard to how different embodiments may be implemented. Many modifications to the depicted environments may be made based on design and implementation requirements.

The present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

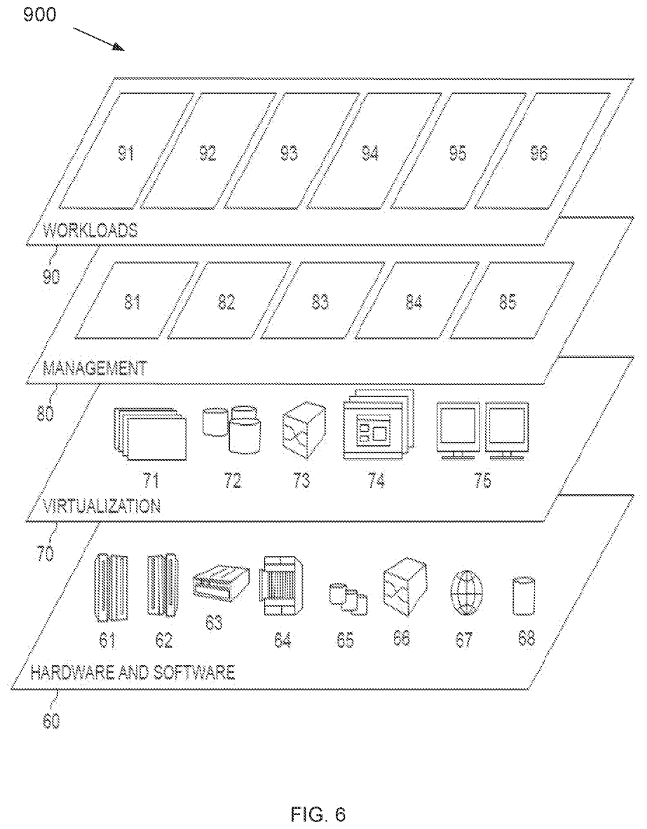

FIG. 4 is a block diagram 700 of internal and external components of computers depicted in FIG. 1 in accordance with an illustrative embodiment of the present invention. It should be appreciated that FIG. 6 provides only an illustration of one implementation and does not imply any limitations with regard to the environments in which different embodiments may be implemented. Many modifications to the depicted environments may be made based on design and implementation requirements.

Data processing system 710 a, b and 750 a, b is representative of any electronic device capable of executing machine-readable program instructions that may include a computer 102 (710a and 750a) and/or a server 112 (710b and 750b). Data processing system 710 a, b and 750 a, b may be representative of a smart phone, a computer system, PDA, or other electronic devices. Examples of computing systems, environments, and/or configurations that may represented by data processing system 710 a, b and 750 a, b may include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 (FIG. 1), and network server 112 (FIG. 1) include respective sets of internal components 710 a, b and external components 750 a, b illustrated in FIG. 6. Each of the sets of internal components 710 a, b includes one or more processors 720, one or more computer-readable RAMs 722, and one or more computer-readable ROMs 724 on one or more buses 726, and one or more operating systems 728 and one or more computer-readable tangible storage devices 730. The one or more operating systems 728, the software program 114 (FIG. 1) and the Computer task offload program 108A (FIG. 1) in client computer 102 (FIG. 1), and the Computer task offload program 108B (FIG. 1) in network server computer 112 (FIG. 1) are stored on one or more of the respective computer-readable tangible storage devices 730 for execution by one or more of the respective processors 720 via one or more of the respective RAMs 722 (which typically include cache memory). In the embodiment illustrated in FIG. 6, each of the computer-readable tangible storage devices 730 is a magnetic disk storage device of an internal hard drive. Alternatively, each of the computer-readable tangible storage devices 730 is a semiconductor storage device such as ROM 724, EPROM, flash memory or any other computer-readable tangible storage device that can store a computer program and digital information.

Each set of internal components 710 a, b, also includes a RAY drive or interface 732 to read from and write to one or more portable computer-readable tangible storage devices 737 such as a CD-ROM, DVD, memory stick, magnetic tape, magnetic disk, optical disk or semiconductor storage device. A software program, such as a computer task offload program 108A and 108B (FIG. 1), can be stored on one or more of the respective portable computer-readable tangible storage devices 737, read via the respective R/W drive or interface 732, and loaded into the respective hard drive 730.

Each set of internal components 710 a, b also includes network adapters or interfaces 736 such as a TCP/IP adapter cards, wireless Wi-Fi interface cards, or 3G or 4G wireless interface cards or other wired or wireless communication links. The Computer task offload program 108A (FIG. 1) and software program 114 (FIG. 1) in client computer 102 (FIG. 1), and the Computer task offload program 108B (FIG. 1) in network server 112 (FIG. 1) can be downloaded to client computer 102 (FIG. 1) from an external computer via a network (for example, the Internet, a local area network or other, wide area network) and respective network adapters or interfaces 736. From the network adapters or interfaces 736, the Computer task offload program 108A (FIG. 1) and software program 114 (FIG. 1) in client computer 102 (FIG. 1) and the Computer task offload program 108B (FIG. 1) in network server computer 112 (FIG. 1) are loaded into the respective hard drive 730. The network may comprise copper wires, optical fibers, wireless transmission, routers, firewalls, switches, gateway computers, and/or edge servers.

Each of the sets of external components 750 a, b can include a computer display monitor 721, a keyboard 731, and a computer mouse 735. External components 750 a, b can also include touch screens, virtual keyboards, touch pads, pointing devices, and other human interface devices. Each of the sets of internal components 710 a, b also includes device drivers 740 to interface to computer display monitor 721, keyboard 731, and computer mouse 735. The device drivers 740, R/W drive or interface 732, and network adapter or interface 736 comprise hardware and software (stored in storage device 730 and/or ROM 724).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

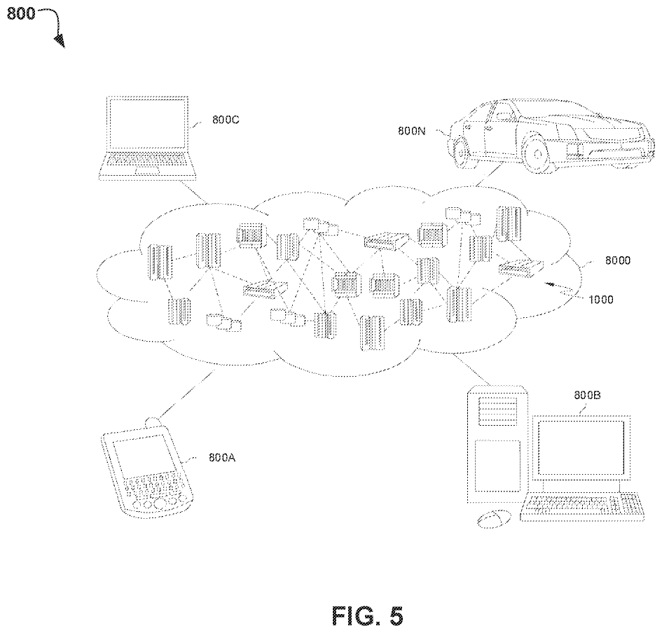

Referring now to FIG. 5, illustrative cloud computing environment 800 is depicted. As shown, cloud computing environment 800 comprises one or more cloud computing nodes 1000 with which local computing devices used by cloud consumers, such as, for example, personal digital assistant (PDA) or cellular telephone 800A, desktop computer 800B, laptop computer 800C, and/or automobile computer system 800N may communicate. Nodes 1000 may communicate with one another. They may be grouped (not shown) physically or virtually, in one or more networks, such as Private, Community, Public, or Hybrid clouds as described hereinabove, or a combination thereof. This allows cloud 8000 to offer infrastructure, platforms and/or software as services for which a cloud consumer does not need to maintain resources on a local computing device. It is understood that the types of computing devices 800A-N shown in FIG. 7 are intended to be illustrative only and that computing nodes 100 and cloud 8000 can communicate with any type of computerized device over any type of network and/or network addressable connection (e.g., using a web browser).

Referring now to FIG. 6, a set of functional abstraction layers 900 provided by cloud computing environment 800 (FIG. 5) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and Computer task offload 96. A computer task offload program 108A, 108B (FIG. 1) may be offered “as a service in the cloud” (i.e., Software as a Service (SaaS)) for applications running on computing devices 102 (FIG. 1) and may automatically select a computing device, among a plurality of computing devices in a collaborative computing environment, to offload and process a computer task.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for automatically selecting a computing device, among a plurality of computing devices in a collaborative computing environment, to offload and process a computer task, comprising:
automatically identifying an off-loadable computer task to be offloaded from a first computing device to a second computing device from the plurality of computing devices, wherein the plurality of computing devices comprises a combination of stationary edge computing devices and moving edge computing devices;
determining a scheduled time for processing the identified off-loadable computer task and an amount of time necessary for processing the off-loadable computer task;
based on the identified off-loadable computer task, the scheduled time, and the determined amount of time for processing the identified off-loadable computer, automatically identifying one or more available computing devices from the plurality of computing devices for processing the identified off-loadable computer task, whereby identifying the one more available computing devices further comprises detecting and correlating computer resource information, location and network information, and travel information associated with each computing device from the plurality of computing devices with the scheduled time and the amount of time necessary for processing the identified off-loadable computer task; and
in response to automatically identifying the one or more available computing devices for processing the identified off-loadable computer task, selecting the computing device from the one or more available computing devices for processing the off-loadable computer task, wherein in response to selecting a moving edge computing device, coordinating the scheduled time and the amount of time for processing the identified off-loadable computer task with a determined travel plan associated with the selected moving edge computing device.

2. The computer-implemented method of claim 1, wherein determining the scheduled time for processing the identified off-loadable computer task and the amount of time necessary for processing the off-loadable computer task further comprises:
determining the scheduled time and the amount of time based on a size of a data associated with the identified off-loadable computer task, a determination of whether processing the identified off-loadable computer task requires downloading and uploading data, and historical data associated with the identified off-loadable computer task.

3. The computer-implemented method of claim 2, wherein the historical data associated with the identified off-loadable computer task includes stored data based on previous processing of the identified off-loadable computer task.

4. The computer-implemented method of claim 1, wherein automatically identifying the one or more available computing devices from the plurality of computing devices for processing the identified off-loadable computer task further comprises:
maintaining a list of the plurality of computing devices in the collaborative computing environment;
tracking the computer resource information, location and network information, and travel information associated with each of the computing devices in the list of the plurality of computing devices based on real-time and historical data associated with each of the computing devices; and
determining the one or more available computing devices by correlating the computer resource information, the location and network information, and the travel information associated with each computing device with the scheduled time for processing the identified off-loadable computer task as well as with the amount of time necessary for processing the identified off-loadable computer task.

5. The computer-implemented method of claim 1, wherein in response to selecting the moving edge computing device, coordinating the scheduled time and the amount of time for processing the identified off-loadable computer task with the determined travel plan associated with the selected moving edge computing device further comprises:
pre-fetching downloadable content associated with the identified off-loadable computer task for the selected moving edge computing device before the scheduled time for processing the identified off-loadable computer task.

6. The computer-implemented method of claim 1, wherein in response to selecting the moving edge computing device, coordinating the scheduled time and the amount of time for processing the identified off-loadable computer task with the determined travel plan associated with the selected moving edge computing device further comprises:
rerouting the selected moving edge computing device for processing the identified off-loadable computer task.

7. The computer-implemented method of claim 1, wherein in response to selecting the moving edge computing device, coordinating the scheduled time and the amount of time for processing the identified off-loadable computer task with the determined travel plan associated with the selected moving edge computing device further comprises:
implementing a travel freeze at a certain point in time before the scheduled time for processing the identified off-loadable computer task.

8. A computer system for automatically selecting a computing device, among a plurality of computing devices in a collaborative computing environment, to offload and process a computer task, comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
automatically identifying an off-loadable computer task to be offloaded from a first computing device to a second computing device from the plurality of computing devices, wherein the plurality of computing devices comprises a combination of stationary edge computing devices and moving edge computing devices;
determining a scheduled time for processing the identified off-loadable computer task and an amount of time necessary for processing the off-loadable computer task;
based on the identified off-loadable computer task, the scheduled time, and the determined amount of time for processing the identified off-loadable computer, automatically identifying one or more available computing devices from the plurality of computing devices for processing the identified off-loadable computer task, whereby identifying the one more available computing devices further comprises detecting and correlating computer resource information, location and network information, and travel information associated with each computing device from the plurality of computing devices with the scheduled time and the amount of time necessary for processing the identified off-loadable computer task; and
in response to automatically identifying the one or more available computing devices for processing the identified off-loadable computer task, selecting the computing device from the one or more available computing devices for processing the off-loadable computer task, wherein in response to selecting a moving edge computing device, coordinating the scheduled time and the amount of time for processing the identified off-loadable computer task with a determined travel plan associated with the selected moving edge computing device.

9. The computer system of claim 8, wherein determining the scheduled time for processing the identified off-loadable computer task and the amount of time necessary for processing the off-loadable computer task further comprises:
determining the scheduled time and the amount of time based on a size of a data associated with the identified off-loadable computer task, a determination of whether processing the identified off-loadable computer task requires downloading and uploading data, and historical data associated with the identified off-loadable computer task.

10. The computer system of claim 9, wherein the historical data associated with the identified off-loadable computer task includes stored data based on previous processing of the identified off-loadable computer task.

11. The computer system of claim 8, wherein automatically identifying the one or more available computing devices from the plurality of computing devices for processing the identified off-loadable computer task further comprises:
maintaining a list of the plurality of computing devices in the collaborative computing environment;
tracking the computer resource information, location and network information, and travel information associated with each of the computing devices in the list of the plurality of computing devices based on real-time and historical data associated with each of the computing devices; and
determining the one or more available computing devices by correlating the computer resource information, the location and network information, and the travel information associated with each computing device with the scheduled time for processing the identified off-loadable computer task as well as with the amount of time necessary for processing the identified off-loadable computer task.

12. The computer system of claim 8, wherein in response to selecting the moving edge computing device, coordinating the scheduled time and the amount of time for processing the identified off-loadable computer task with the determined travel plan associated with the selected moving edge computing device further comprises:
pre-fetching downloadable content associated with the identified off-loadable computer task for the selected moving edge computing device before the scheduled time for processing the identified off-loadable computer task.

13. The computer system of claim 8, wherein in response to selecting the moving edge computing device, coordinating the scheduled time and the amount of time for processing the identified off-loadable computer task with the determined travel plan associated with the selected moving edge computing device further comprises:
rerouting the selected moving edge computing device for processing the identified off-loadable computer task.

14. The computer system of claim 8, wherein in response to selecting the moving edge computing device, coordinating the scheduled time and the amount of time for processing the identified off-loadable computer task with the determined travel plan associated with the selected moving edge computing device further comprises:
implementing a travel freeze at a certain point in time before the scheduled time for processing the identified off-loadable computer task.

15. A computer program product for automatically selecting a computing device, among a plurality of computing devices in a collaborative computing environment, to offload and process a computer task, comprising:
one or more tangible computer-readable storage devices and program instructions stored on at least one of the one or more tangible computer-readable storage devices, the program instructions executable by a processor, the program instructions comprising:
automatically identifying an off-loadable computer task to be offloaded from a first computing device to a second computing device from the plurality of computing devices, wherein the plurality of computing devices comprises a combination of stationary edge computing devices and moving edge computing devices;
determining a scheduled time for processing the identified off-loadable computer task and an amount of time necessary for processing the off-loadable computer task;
based on the identified off-loadable computer task, the scheduled time, and the determined amount of time for processing the identified off-loadable computer, automatically identifying one or more available computing devices from the plurality of computing devices for processing the identified off-loadable computer task, whereby identifying the one more available computing devices further comprises detecting and correlating computer resource information, location and network information, and travel information associated with each computing device from the plurality of computing devices with the scheduled time and the amount of time necessary for processing the identified off-loadable computer task; and
in response to automatically identifying the one or more available computing devices for processing the identified off-loadable computer task, selecting the computing device from the one or more available computing devices for processing the off-loadable computer task, wherein in response to selecting a moving edge computing device, coordinating the scheduled time and the amount of time for processing the identified off-loadable computer task with a determined travel plan associated with the selected moving edge computing device.

16. The computer program product of claim 15, wherein determining the scheduled time for processing the identified off-loadable computer task and the amount of time necessary for processing the off-loadable computer task further comprises:
determining the scheduled time and the amount of time based on a size of a data associated with the identified off-loadable computer task, a determination of whether processing the identified off-loadable computer task requires downloading and uploading data, and historical data associated with the identified off-loadable computer task.

17. The computer program product of claim 16, wherein the historical data associated with the identified off-loadable computer task includes stored data based on previous processing of the identified off-loadable computer task.

18. The computer program product of claim 15, wherein automatically identifying the one or more available computing devices from the plurality of computing devices for processing the identified off-loadable computer task further comprises:
maintaining a list of the plurality of computing devices in the collaborative computing environment;
tracking the computer resource information, location and network information, and travel information associated with each of the computing devices in the list of the plurality of computing devices based on real-time and historical data associated with each of the computing devices; and
determining the one or more available computing devices by correlating the computer resource information, the location and network information, and the travel information associated with each computing device with the scheduled time for processing the identified off-loadable computer task as well as with the amount of time necessary for processing the identified off-loadable computer task.

19. The computer program product of claim 15, wherein in response to selecting the moving edge computing device, coordinating the scheduled time and the amount of time for processing the identified off-loadable computer task with the determined travel plan associated with the selected moving edge computing device further comprises:
pre-fetching downloadable content associated with the identified off-loadable computer task for the selected moving edge computing device before the scheduled time for processing the identified off-loadable computer task.

20. The computer program product of claim 15, wherein in response to selecting the moving edge computing device, coordinating the scheduled time and the amount of time for processing the identified off-loadable computer task with the determined travel plan associated with the selected moving edge computing device further comprises:
rerouting the selected moving edge computing device for processing the identified off-loadable computer task.
